(19) United States
(12) Patent Application Publication
(10) Pub. No.: US 2017/0105076 A1
(43) Pub. Date: Apr. 13, 2017

(54) HEARING ASSISTANCE SYSTEM AND METHOD

(71) Applicant: SONOVA AG, Stäfa (CH)

(72) Inventor: Stephan GEHRING, Uerikon (CH)

(73) Assignee: SONOVA AG, Stäfa (CH)

(21) Appl. No.: 15/313,668

(22) PCT Filed: May 28, 2014
(86) PCT No.: PCT/EP2014/061147

§ 371 Date: Nov. 23, 2016

(51) Int. Cl. H04R 25/00

(52) U.S. Cl. CPC H04R 25/552; H04R 25/305; H04R 2225/55

(57) ABSTRACT

A hearing assistance system having a first and second hearing assistance devices worn in first second ears of a user, each hearing assistance device having an interface for receiving an external data stream and stream access information from an external data source, and being adapted to exchange data with the other hearing assistance device. Each hearing assistance device is switchable between a meta-information scanning mode for receiving information from the external data source device and a sleeping mode. The hearing assistance devices are adapted to synchronize by data exchange between each other in such manner that, at least for some time, one of the hearing assistance devices is in the scanning mode and the other hearing assistance device is in the sleeping mode, each hearing assistance device being adapted to notify the other the hearing assistance device that it has received stream access information from the external data source device.

### BACKGROUND OF THE INVENTION

Field of the Invention

The invention relates to a hearing assistance system comprising a first hearing assistance device to be worn at a first one of a user's ears and a second hearing assistance device to be worn at a second one of the user's ears, with both hearing assistance devices comprising an interface for receiving a wireless data stream from an external data source device and for receiving meta-information from the external data source device required to access the data stream.

Description of Related Art

Wireless systems may transmit audio signals and other data (hereinafter referred to as “external data stream”) from a source (hereinafter referred to as “external data source”) to one or more destinations. Usually, such external data sources may transmit meta-information, such as transmission-related parameters like channel hopping maps, link security information or information about the content of the external data stream, in addition to the external data stream (such meta-information required for accessing the external data stream hereinafter will be referred to as “stream access information”).

A priori, it is not known by the receiver devices whether there are external data sources within range—in particular if the receiver devices are mobile, as in the case of hearing assistance devices. In order to receive an external data stream, receiver devices, such as hearing assistance devices, consequently have to scan for external data sources, for example by scanning for meta-information transmitted by the external data source. Once a source is detected, the receiving device may use the received meta-information to access and receive the external data stream in order to, for example, present the broadcast signal to the user. A data source may transmit meta-information concerning wireless link access by emitting beacons, i.e., regular transmissions of network-related information. Thus, scanning for a data source is required to detect a beaconing device. Scanning is typically carried out by listening in a duty-cycled fashion, i.e., the scanning receiver device is generally in a low-power state and periodically wakes up to scan for a beaconing device within range. Once a beacon signal is found, the receiving device may connect to the beaconing device; otherwise, it returns to the low power state. The purpose of such duty cycling is to conserve power, resulting in a trade-off between power consumption and the time required for detecting a data source device.

Bluetooth networks have a Piconet controller, such as a mobile phone, emitting beacons. The devices forming part of such Bluetooth network generally maintain a bidirectional point-to-point connection, so that, for example, a device acting as an audio source for a receiving device, such as a headset, is not able to broadcast an audio stream, but rather has to separately connect to each receiving device in the network. Further, such bidirectional connection is limited to the range of the device having the most restricted power budget and antenna efficiency.

U.S. Pat. No. 9,398,399 B2 relates to a Bluetooth communication system, wherein a Bluetooth communication unit detects a Bluetooth signal via a first antenna and, upon detecting the Bluetooth signal, switches to a second antenna which is shared between the Bluetooth communication unit and a WiFi communication unit for establishing a Bluetooth communication link.

U.S. Pat. No. 8,599,824 B2 relates to a Bluetooth communication system wherein a portion of a synchronization code embedded in a Piconet packet is used for a synchronization process, wherein a synchronization code in a received Piconet packet may be punctured and the punctured version of the synchronization code may be compared to the punctured portion of a reference synchronization sequence using correlation in order to determine if a packet synchronization has been detected.

U.S. Pat. No. 8,457,554 B2 relates to a Bluetooth communication system, wherein, in the scanning procedure, a magnitude of the received signal at each frequency is stored where the magnitude exceeds a threshold level, wherein a type of signals in the received signal is determined based on a bandwidth of the signals, and wherein a Bluetooth inquiry scan is initiated if the determined type is an inquiry signal.

### SUMMARY OF THE INVENTION

It is an object of the invention to provide for a binaural hearing assistance system which is capable of receiving a wireless data stream from an external data source device and which has relatively low power consumption while being able to connect to the external data source device relatively fast.

It is a further object to provide for a corresponding hearing assistance method.

According to the invention, these objects are achieved by a hearing assistance system and by a hearing assistance method as described herein.

The invention is beneficial in that, by distributing the scanning activities necessary for receiving stream access information concerning access of an external data stream from an external data source device onto both hearing assistance devices by switching the hearing assistance devices between a scanning mode and a sleeping mode in a synchronized manner, the total power consumption required for the scanning process at a given scanning rate can be reduced compared to the case in which both hearing assistance devices scan independently; alternatively, rather than increasing battery lifetime, the scanning rate could be increased in order to reduce the time required to get access to the data stream.

In practice, there may be some overlap of the scanning actions of the two hearing assistance devices, i.e., one of the hearing assistance devices may still remain in the scanning mode for some time, while the other hearing assistance device already has switched from the sleeping mode into the scanning mode as well. However, in some cases, it may be desirable to avoid such overlap of the scanning actions in order to minimize total power consumption. Of course, both hearing assistance devices may be simultaneously in a sleeping mode for some time, in particular during times when no or only little scanning activity is desired.

According to one embodiment the hearing assistance devices may be synchronized with regard to the scanning activity by exchanging handover messages, i.e., the device in the scanning mode transmits, after elapse of the scanning period, a handover message to the other device in order to cause the other device to switch from the sleeping mode into the scanning mode.

According to an alternative example, the scanning activities of the hearing assistance devices may be synchronized by a timer in each device for indicating the elapse of the scanning period, with the devices regularly synchronizing their timers by data exchange.

Hereinafter, examples of the invention will be described with reference to the accompanying drawings.

### BRIEF DESCRIPTION OF THE DRAWINGS

FIG. 1 is a schematic representation of an example of a hearing assistance system according to the invention when used with a wireless data source;

FIG. 2 is a block diagram of an example of a hearing assistance system according to the invention;

FIG. 3 is a rough representation of an example of the scanning activity of a hearing assistance system according to the invention as a function of time; and

FIG. 4 is an example of a message sequence chart of a scanning procedure according to the invention.

### DETAILED DESCRIPTION OF THE INVENTION

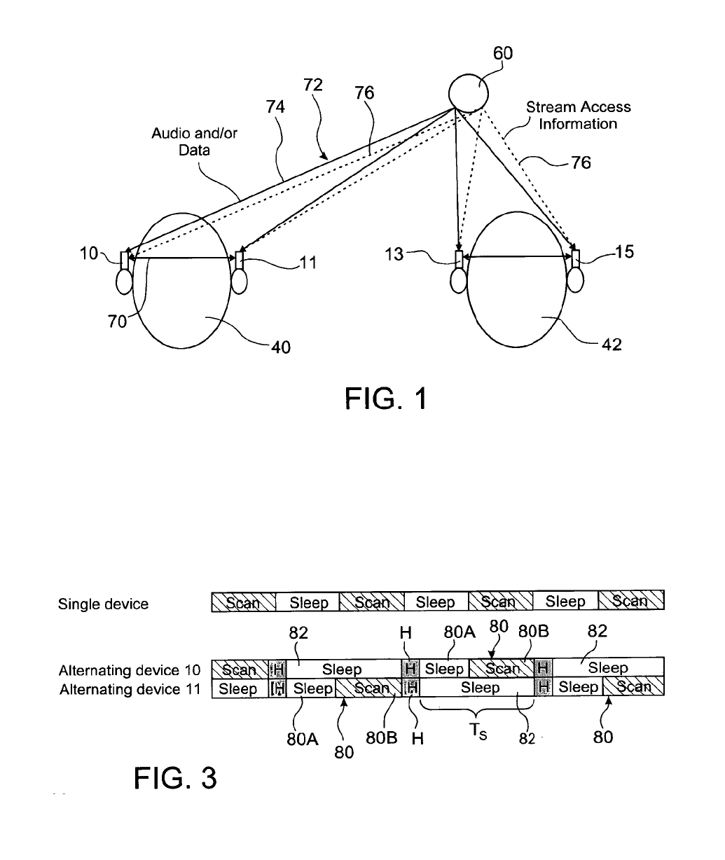

FIG. 1 is a schematic representation of an example of a hearing assistance system according to the invention, comprising a first hearing assistance device 10 worn at one ear of a first user 40 and a second hearing assistance device 11 worn at the other ear of the user 40; in addition, a further pair of hearing assistance devices 13, 15 worn at the ears of a second user 42 and which are similar to the first pair of hearing assistance devices 10, 11 and hence will not be further described. The hearing assistance devices 10, 11 comprise an interface for data exchange between the devices 10, 11 in order to implement a binaural hearing assistance system via a link 70 which may be wired or wireless. The hearing assistance devices 10, 11 are also adapted to receive a wireless external data stream 74 from an external data source device 60 and to receive meta-information (“stream access information”) 76 transmitted from the external data source device 60 and required to access the external data stream 74; the external data stream 74 and the stream access information 76 are transmitted from the external data source device 60 via a wireless link 72.

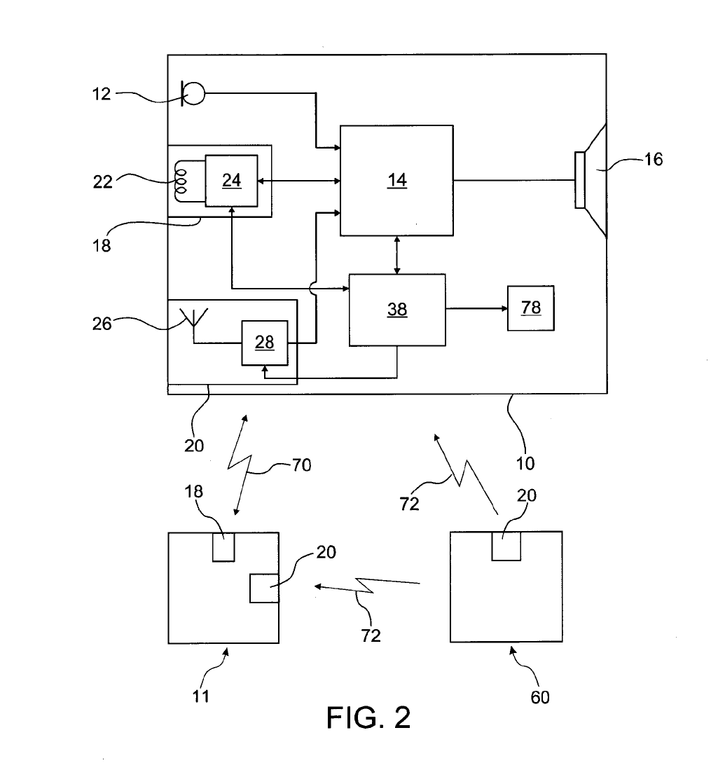

FIG. 2 is a block diagram of an example of a system comprising a first hearing assistance device 10 to be worn at one ear of a user, a second hearing assistance device 11 to be worn at the other ear of the user and an external device 60.

The hearing assistance devices 10, 11 may be hearing aids, such as BTE (behind the ear), ITE (in the ear) or CIC (completely in the channel) hearing aids. However, the hearing assistance devices, for example, also could be an auditory prosthesis, such as a cochlear implant device. According to another example, the hearing assistance devices could form a headset or headphones for a person with normal hearing.

According to the example of FIG. 2, the hearing assistance devices 10, 11 are electro-acoustic hearing aids comprising a microphone arrangement 12 for capturing audio signals from ambient sound, an audio signal processing unit 14 for processing the captured audio signals and an electro-acoustic output transducer (loudspeaker) 16 for stimulation the user's hearing according to the processed audio signals (these elements are shown in FIG. 1 only for the hearing aid 10).

The hearing aids 10, 11 also comprise a first wireless interface 18 and a second wireless interface 20. The first interface 18 may be designed for a shorter range and lower power consumption than the second interface 20. The first interface 18 comprises an antenna 22 and a transceiver 24, and the second interface comprises an antenna 26 and a transceiver 28.

The first interface 18 is provided for enabling wireless data exchange between the first hearing aid 10 and the second hearing aid 11 via the wireless link 70 which, according to one example, may be an inductive link which may operate, for example, in a frequency range of 6.765 MHz to 13.567 MHz, such as at 10.6 MHz. For example, the first interface 18 may be designed to form part of a hearing instrument body area network (HIBAN). However, rather than being implemented as an inductive link, the wireless link 70 may be a far-field link, such as a proprietary digitally modulated link operating in the 2.4 GHz ISM band, or a standard link, such as Bluetooth or Bluetooth Low Energy.

The link 70 serves to realize a binaural hearing assistance system, allowing the hearing aids 10, 11 to exchange audio signals and/or control data and status data, such as the present settings of the hearing aids 10, 11.

The second interface 20 is provided for data exchange via a wireless link 72 from an external device 60, for example for receiving an external data stream from an external device 60 acting as an external data source. For example, the second interface 20 may be adapted to operate in a frequency range of 0.38 GHz to 5.825 GHz, preferably at frequencies around 2.4 GHz in the ISM band. For example, the second interface 20 may be a Bluetooth interface, a WLAN (WiFi) interface or a GSM interface.

Preferably, the external data stream may be a mono or stereo audio stream, whereby left and right channels of the audio signal may be provided to the left ear and right ear hearing assistance device jointly or individually. The external device 60 may be a public announcement system (like in an airport) or a local device, like a communication device, such as a mobile phone, a DECT phone device or an internet phone device (“voice over IP”), or it may be a consumer electronics device, like a TV-set, a personal computer, a tablet computer, a radio device, a HiFi set or a media player, or a wireless microphone, or it may be a hearing assistance device to be worn by another person. The content may be sent in a completely open manner (without any access restriction) or it can be secured against eavesdropping, e.g. with encryption.

The hearing aids 10, 11 also comprise a controller 38 for controlling operation of the hearing aids 10, 11, with the controller 38 acting on the signal processing unit 14 and the transceivers 24 and 28.

The external device 60 likewise comprises an interface 20 for transmitting data/signals of the external data stream via the external data link 72 to the hearing aids 10, 11.

The binaural link 70 may be a wireless link, as shown in FIG. 2, or it may be a wired link, such as a CRQS (Contralateral Routing of Signal) link.

In case that the binaural link 70 is a wireless link, the protocol/interface for the binaural link 70 and the external data link 72 may be the same (in this case the interface 20 used for the binaural link 70 also could be used for data reception from the external device 60 via the link 72) or it may be different (requiring two separate interfaces 18, 20 for the links 70 and 72, respectively); the protocol/interface may be proprietary or it may be standard-based (such as Bluetooth, WLAN or GSM).

In order to receive the external data stream 74 from the external device 60, the respective hearing assistance device 10, 11 has to be aware that such stream 74 is available, and the meta-information required for accessing the stream 74 (“stream access information”) has to be available for the hearing assistance device 10, 11. Such stream access information 76 is transmitted by the external device 60 via the link 72 so that the hearing assistance devices 10, 12 have to regularly scan for such stream access information 76 in order to be able to quickly get access to the data stream 74, once such stream is available and reception of the stream is desired. Such necessary scanning process consumes resources of the respective hearing assistance device, in particular, with regard to power and processor load. Therefore, the present invention seeks to distribute the scanning process between two hearing assistance devices 10, 11 which are already connected for mutual data exchange, such as via a binaural link 70 (it is noted that the two hearing assistance devices, rather than being directly connected via such binaural link 70, may be connected via a relay device connected in-between the two hearing assistance devices for relaying synchronization messages between the hearing assistance devices; in particular, the external device 60 may relay such messages).

A schematic example of this principle is shown in FIG. 3, according to which each hearing assistance device 10, 11 switches between a scanning mode (indicated at 80 in FIG. 3) and a sleeping mode (indicated at 82 in FIG. 3) in a synchronized manner, so that one of the two devices 10, 11 is in the scanning mode, while the other one is in the sleeping mode, and vice versa. During the scanning mode, the hearing assistance device scans for stream access information transmitted from the external data source device 60, and in the sleeping mode the hearing assistance device does not scan for such stream access information. Switching between the scanning mode and the sleeping mode occurs after elapse of a scanning period T. In the example of FIG. 3, the scanning mode 80 is duty-cycled, comprising a passive period 80A followed by an active period 80B, with the actual scanning action taking place in the active period and with no scanning action taking place during the passive period 80A (i.e., during the passive period the receiver/transceiver is “sleeping” with regard to scanning actions). In the example of FIG. 3 the scanning duty cycle is about 50%; for comparison, the corresponding scanning action of a single device is shown in the upper part of FIG. 3.

According to one embodiment, switching between the scanning mode and the sleeping mode is caused by the exchange of handover messages H between the hearing assistance devices. More in detail, the hearing assistance device which is in the scanning mode transmits, after elapse of the scanning period, a handover message H to the other hearing assistance device, which is in the sleeping mode, and then switches to the sleeping mode, whereas the other hearing assistance device, after receipt of the handover message H, switches from the sleeping mode into the scanning mode, as illustrated schematically in FIG. 3. During the next scanning period the roles of the two hearing assistance devices are interchanged, i.e., the previously scanning device now is sleeping, whereas the previously sleeping device now is scanning, until the scanning period has elapsed, and, after transmission of a handover message H, the device in the sleeping mode is reactivated, while the other device enters the sleeping mode, thereby resuming the original roles, etc.

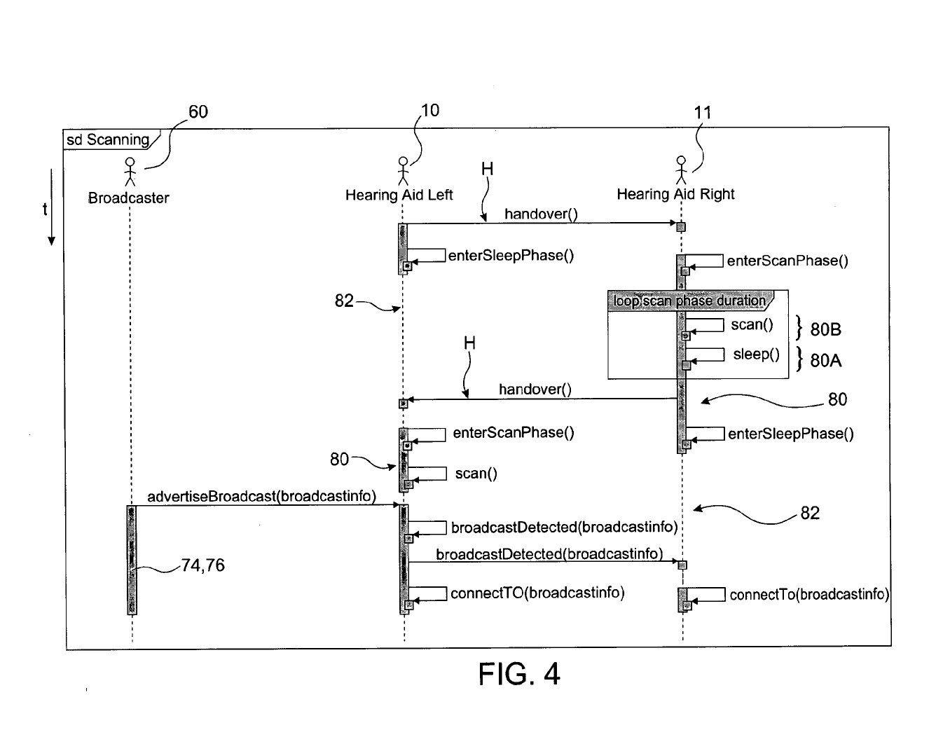

A more detailed illustration of an example of such type of scanning procedure is shown in FIG. 4, according to which the left ear hearing aid 10 terminates the scanning mode 80 by transmitting a handover message H to the right ear hearing aid 11 and enters the sleeping mode 82, with the right ear hearing aid 11, upon receipt of the handover message H, entering the scanning mode 80.

As already mentioned above, the scanning mode may be conducted in a duty-cycled manner itself, whereby a short period 80B of scanning activity is followed by a short period 80A of sleep (or vice versa), with this sequence typically being repeated several times.

Once the scanning period has elapsed, the right ear hearing aid 11 transmits a handover message H to the left ear hearing aid 10 and enters the sleeping mode 82, whereas the left ear hearing aid 10, upon receipt of the handover message H, enters the scanning mode 80. During that scanning mode of the left ear hearing aid 10, the external data source device 60 starts transmission of an external data stream 74 and stream access information 76 (or enters the range of the hearing aid transceivers) at a time t_{b}, so that the left ear hearing aid 10 receives stream access information 76 when being in the scanning mode.

The left ear hearing aid 10, after having detected the availability of the external device 60 by receipt of the stream access information 76, then decides whether or not to connect to the external device 60. In case that the decision is “yes”, the left ear hearing aid 10 transmits the received stream access information 76 via the binaural link 70 to the right ear hearing aid 11, whereupon both hearing aids 10, 11 are able to receive the data stream 74, i.e., both hearings 10, 11 may connect to the external device 60. In case that the decision is “no”, no such message is sent to the right ear hearing aid 11 and the left ear hearing aid 10 continues to operate in the scanning mode until it is time to switch roles again.

Rather than transmitting the received stream access information 76 to the other hearing aid, the hearing aid which has detected the stream access information 76 may transmit just a message to the other hearing aid notifying the other hearing aid with regard to the availability of stream access information, without providing the stream access information itself via the binaural link 70 to the other hearing aid. In this case the other hearing aid, upon receipt of the notification message, starts to scan itself for the stream access information 76 from the external device 60. Since such process it takes more time for the hearing aid in the sleeping mode to connect to the external device 60, such procedure is less preferred than the above-mentioned transmission of the stream access information 76 via the binaural link 70.

According to one embodiment, the duration of the scanning period may be constant, corresponding to a predefined time interval; alternatively, the duration of the scanning period may be individually determined by that hearing assistance device which is in the scanning mode. In the latter case, the duration of the scanning period may be determined as a function of the available battery capacity, the geographic location, the time of the day or the use context, such as a presently prevailing auditory scene as determined by an auditory scene classifier of the hearing assistance device. According to a further alternative embodiment, the duration of the scanning period may be negotiated between the two hearing assistance devices, i.e., it may be determined based on information provided by both hearing assistance devices, such as available battery capacity in each of the devices.

The duration of the scanning period may be constant, or it may be dithered to provide for a varying duration. The duration of the scanning period is a tradeoff between the required power consumption and the time required to connect to the external device 60.

Providing the scanning period in a dithered manner may enhance chances of detecting transmission of stream access information 76 from an external device 60 which transmits the stream access information at a fixed period.

According to one example, the hearing assistance devices may be designed to synchronize after power-on with regard to the scanning mode/sleeping mode switching after the first handover message H has been transmitted. i.e., the two devices may independently scan after power-on until the first handover message is received by one of the devices. In this case, dithering of the scanning periods may be beneficial in order to avoid that in case that the two devices start scanning at exactly the same time none of the devices ever receives a handover message H because both devices send the handover message at the same time and hence do not receive the other device's message due to half-duplex transmission.

According to one example, the hearing assistance devices are designed such that, when after power-on the hearing assistance devices connect to each other via the binaural link 70, a fixed one of the hearing assistance devices is set to the scanning mode, while the other one is set to the sleeping mode, so that always the same device starts scanning, rather than both devices starting to scan independently prior to exchanging the first handover message as in the previous example.

According to a further alternative, the two hearing assistance devices may negotiate which one of the devices should start to scan, i.e., the decision is taken based on information provided by both hearing assistance devices.

Rather than synchronizing the two hearing assistance devices with regard to the scanning/sleeping mode by exchanging handover messages, the two hearing assistance devices may be synchronized according to a timer signal, i.e., each of the hearing assistance devices comprises a timer for indicating the beginning and the elapse of the scanning period and of the sleeping period in order to cause the respective hearing assistance device to switch from the sleeping mode to the scanning mode and vice versa (such timer is indicated at 78 in FIG. 2). Such approach requires that the devices initially synchronize and thereafter regularly resynchronize their timers using the binaural link 70 (and offset the scanning action accordingly). Preferably, the timers are periodically resynchronized, with the synchronization period being selected according to the clock stability in the two devices. This approach has as a benefit that the power required for exchanging the handover messages may be reduced, since resynchronization messages may be sent less frequently.

A distributed scanning procedure also may take place in case that one of the hearing assistance devices or both hearing assistance devices are already connected to and receive data from another external data source (or transmit data to a sink) or otherwise communicate with another device; in such case, scanning for alternative data/audio sources in principle can be performed in the same manner as described above, exploiting gaps in the other communication interactions in order to scan for alternative sources, or briefly interrupting the primary communication for this purpose.

In order to receive a handover message from the device in the scanning mode via the binaural link, the device in the sleeping mode must periodically wake up (or wake up in a dithered manner within a time window) to determine whether a message is arriving from the device in the scanning mode. Such wake-up period for binaural messages may be larger than the scanning period in the scanning mode, and the duration of the binaural scanning for messages may be shorter as well, thus saving power.

Typically, the hearing assistance devices do not know at which frequencies the external data source device 60 transmits (often such transmission occurs according to a frequency hopping scheme), whereas the hearing assistance devices usually know at which frequency the other hearing assistance device will transmit messages via the binaural link 70. Thus, scanning for stream access information 76 from the external device 60 typically is more power consuming than scanning for messages transmitted via the binaural link 70, so that distributing the scanning for stream access information 76 from the external device 60 between the two hearing assistance devices allows power to be saved. The actual reduction in current depends on the duty cycle and the scan duration.

Thus, the present invention, by distributing the scanning action onto two binaurally connected hearing assistance devices, allows power consumption to be reduced (or to increase the scanning rate—and accordingly reduce the average time needed to detect an external device, if the power consumption is to be kept constant). In particular, no third device is needed to perform the scanning action for the external device, so that the hearing assistance devices are enabled to autonomously detect other communication sources.

The stream access information allowing a receiving device to connect to the source may be emitted by the external data source periodically or in a dithered manner in order to avoid constant collisions with another collocated source, and it may be transmitted in parallel to the data stream (typically by interspersing the external data stream with occasional stream access information packets, although in principle with some transmitters it may be possible to transmit data stream packets and stream access information packets simultaneously), or it may be transmitted also at times when there is no data stream.

The external data stream transmitted by the external source device typically will be a broadcast stream in the sense that it is transmitted without addressing a specific receiver device, i.e., without specifying a receiver address, but it also could be technically transmitted as an unicast stream (addressing only one specific receiver device), a multicast stream (addressing several specific receiver devices) or a bidirectional stream (addressing only one specific receiver device).

What is claimed is:

1. A hearing assistance system, comprising a first hearing assistance device (10) to be worn at a first one of a user's ears and a second hearing assistance device (11) to be worn at a second one of the user's ears,
each hearing assistance device comprising an interface (20) for receiving a wireless external data stream (74) from an external data source device (60) and for receiving stream access information (76) transmitted from the external data source device and required to access the data stream,
each hearing assistance device being adapted to exchange data with the other hearing assistance device,
each hearing assistance device being adapted to switch, after elapse of a scanning period, between a scanning mode (80) in which the hearing assistance device scans for meta-information transmitted from the external data source and a sleeping mode (82) in which the hearing assistance device does not scan for stream access information,
wherein the hearing assistance devices are adapted to synchronize by data exchange between the first hearing assistance device and the second hearing assistance device in such manner that at least for some time one of the hearing assistance devices is in the scanning mode and the other one of the hearing assistance devices is in the sleeping mode, and
wherein each hearing assistance device is adapted to notify, after having received stream access information from the external data source device in the scanning mode, the other one of the hearing assistance devices that it has received stream access information from the external data source device.

2. The system of claim 1, wherein each hearing assistance device (10, 11) is adapted to transmit the received stream access information (76) to the other one of the hearing assistance devices in addition to notifying the other one of the hearing assistance devices.

3. The system of claim 1, wherein each hearing assistance device (10, 11) is adapted to transmit, after elapse of the scanning period, a handover message (H) to the other one of the hearing assistance devices in order to cause the other one of the hearing assistance devices switch from the sleeping mode (82) to the scanning mode (80).

4. The system of claim 1, wherein the hearing assistance devices (10, 11) are constructed such that, after power-on, the hearing assistance devices synchronize with regard to scanning mode (80) and sleeping mode (82) after a first handover message (H) has been received by one of the hearing assistance devices.

5. The system of claim 3, wherein the duration of the scanning period is constant.

6. The system of claim 3, wherein the duration of the scanning period is individually determined by that hearing assistance device (10, 11) which is presently in the scanning mode.

7. The system of claim 6, wherein the duration of the scanning period is determined as a function of at least one of the available battery capacity, the geographic location, the time of the day, and on an auditory scene as determined by an auditory scene classifier.

8. The system of claim 3, wherein the duration of the scanning period is determined based on information provided by both hearing assistance devices (10, 11).

9. The system of claim 1, wherein each hearing assistance device (10, 11) comprises a timer (78) for indicating the beginning and the elapse of the scanning period in order to cause the hearing assistance device to switch from the sleeping mode (82) to the scanning mode (80) and from the scanning mode to the sleeping mode, respectively, with the hearing assistance devices being adapted to regularly synchronize the timers by mutual data exchange.

10. The system of claim 9, wherein the hearing assistance devices (10, 11) are adapted to periodically synchronize the timers (78).

11. The system of claim 1, wherein the hearing assistance devices (10, 11) are constructed such that, when after power-on the hearing assistance devices connect to each other via the interface (18, 20), it is decided, based on information provided by both hearing assistance devices, which one of the hearing assistance devices is first set to the scanning mode (80), while the other one is set to the sleeping mode (82).

12. The system of claim 1, wherein each hearing assistance device (10, 11) is adapted to continue operation in the scanning mode (80) after having decided to not connect to an external data source device from which stream access information has been received.

13. The system of claim 1, wherein each hearing assistance device (10, 11) is adapted to decide, after having received stream access information (76) from the external data source device (60) in the scanning mode, whether or not to connect to the external data source device, and to notify the other one of the hearing assistance devices via the interface (18, 20) that it has received stream access information from the external data source device only in case that the decision is to connect to the external data source device.

14. The system of claim 1, wherein each hearing assistance device (10, 11) comprises an additional interface (18) for the data exchange with the other hearing assistance device (11, 10).

15. The system of claim 14, wherein the additional interface of the hearing assistance devices (10, 11) is a wired CROS-interface.

16. The system of claim 14, wherein the additional interface of the hearing assistance devices is a wireless interface (18).

17. The system of claim 1, wherein the interface (20) for receiving the external data stream (74) from the external data source (60) device is suitable also for wireless data exchange between the hearing assistance devices (10, 11).

18. The system of claim 17, wherein the interface (20) of the hearing assistance devices (10, 11) is a BLUETOOTH® interface or a WiFi interface.

19. The system of claim 14, wherein the additional interface (18) of the hearing assistance devices (10, 11) is a BLUETOOTH® interface or a WiFi interface.

20. The system of claim 14, wherein the additional interface (18) of the hearing assistance devices (10, 11) is a proprietary interface.

21. The system of claim 19, wherein the additional interface of the hearing assistance devices (10, 11) is an inductive interface (18).

22. The system of claim 1, wherein at least one of the hearing assistance devices is a hearing aid (10, 11) or an auditory prosthesis.

23. The system of claim 1, wherein the hearing assistance devices form a headset or headphones.

24. The system of claim 1, wherein the external data stream (72, 74) from the external data source device (60) is an audio data stream.

25. The system of claim 1, wherein the external data stream (72, 74) from the external data source device (60) is a broadcast, multicast or unicast stream.

26. The system of claim 1, wherein the hearing assistance devices (10, 11) are adapted to synchronize by data exchange between the first hearing assistance device and the second hearing assistance device in such manner that at any time, when one of the hearing assistance devices is in the scanning mode, the other one of the hearing assistance devices is in the sleeping mode.

27. A method of providing hearing assistance to a user wearing a first hearing assistance device (10) at a first one of the user's ears and a second hearing assistance device (11) at a second one of the user's ears, the method comprising:
connecting the hearing assistance devices for exchanging data between the first hearing assistance device and the second hearing assistance device,
synchronizing, by data exchange between the first hearing assistance device and the second hearing assistance device, the hearing assistance devices in such manner that at a time one of the hearing assistance devices is in a scanning mode (80) in which the hearing assistance device scans for stream access information (76) transmitted from an external data source (60) and required to access an external data stream (74) transmitted from the external data source and the other one of the hearing assistance devices is in a sleeping mode (82) in which the hearing assistance device does not scan for stream access information,
switching, after elapse of a scanning period, between the scanning mode and the sleeping mode, in such manner that at least for some time one of the hearing assistance devices is in the scanning and the other one of the hearing assistance devices is in the sleeping mode,
deciding, after having received stream access information from the external data source device in the scanning mode, whether or not to connect to the external data source device, and notifying, if the decision is to connect to the external data source device, the other one of the hearing assistance devices that it has received stream access information from the external data source device.

28. The method of claim 27, wherein the external data source device (60) is an one of a mobile phone, a land line phone or an internet phone device.

29. The method of claim 27, wherein the external data source device (60) is one of a TV-set, a personal computer, a table computer, a radio device, a media player or a generic remote control.

30. The method of claim 27, wherein the external data source device (60) is part of public announcement system.

31. The method of claim 27, wherein the external data source device (60) is a hearing assistance device to be worn by another person.

32. The method of claim 27, wherein the hearing assistance devices (10; 11) are directly connected with each other via a binaural link (70).
